(19) United States
(12) Patent Application Publication
(10) Pub. No.: US 2023/0368475 A1
(43) Pub. Date: Nov. 16, 2023

(54) Multi-Device Content Handoff Based on Source Device Position

(71) Applicant: Apple Inc., Cupertino, CA (US)

(72) Inventors: Ada Y. Chan, Cupertino, CA (US); Adam Roben, Swarthmore, PA (US)

(21) Appl. No.: 18/140,175

(22) Filed: Apr. 27, 2023

Related U.S. Application Data
(60) Provisional application No. 63/340,060, filed on May 10, 2022.

(51) Int. Cl. G06T 19/00; G06T 7/70; G06V 20/20

(52) U.S. Cl. CPC G06T 19/006; G06T 7/70; G06V 20/20

(57) ABSTRACT

Various implementations disclosed herein include devices, systems, and methods that facilitate the use of application content such as text, images, video, and 3D models in XR environments. In some implementations, a first device (e.g., an HMD) provides an indicator corresponding to a content item currently/recently used on a second device (e.g., a mobile phone), where the indicator is positioned based on a position of that second device. A user may visit a website on their mobile phone and, while using their HMD, see a view having a depiction of their mobile phone with a nearby indicator (e.g., an affordance) for accessing that same website on the HMD. The affordance may be positioned based on (e.g., next to) the mobile phone such that its positioning provides an intuitive user experience or otherwise facilitates easy understanding of the use of content item on the other device.

### CROSS-REFERENCE TO RELATED APPLICATIONS

This application claims the benefit of U.S. Provisional Application Ser. No. 63/340,060 filed May 10, 2022, which is incorporated herein in its entirety.

### TECHNICAL FIELD

The present disclosure generally relates to electronic devices that provide content within extended reality (XR) environments, including views that include content based on use of the content on other devices within such environments.

### BACKGROUND

Existing extended reality (XR) systems may be improved with respect to providing means for users to experience content items on multiple devices.

### SUMMARY

Various implementations disclosed herein include devices, systems, and methods that facilitate the use of content items such as text, images, videos, and 3D models in XR environments. In some implementations, a first device (e.g., an HMD) provides an indicator corresponding to a content item currently/recently used on a second device (e.g., a mobile phone), where the indicator is positioned based on a position of that second device. For example, a user may visit a website on their mobile phone and, while using their HMD, see a view having a depiction of their mobile phone with a nearby indicator (e.g., an affordance) for accessing that same website on the HMD. The affordance may be positioned based on (e.g., next to) the mobile phone such that its positioning provides an intuitive user experience or otherwise facilitates easy understanding of the use of the content item on the other device.

In some implementations, a processor performs a method by executing instructions stored on a computer readable medium. The method acquires sensor data during use of the first device in a physical environment that includes a second device. The sensor data may include RGB camera sensor data, depth sensor data, densified depth data, audio data, or various other types of sensor data that the first device captures to provide user experiences or understand the physical environment or the devices and users within it.

The method identifies a position of the second device in the physical environment based on the sensor data. The position of the second device may correspond to a 3D (e.g., x, y, z coordinate) position in a world coordinate system, a relative position of the second device to the first device, a distance and direction of the second device from the first device, a 2D position of the second device within a captured image of the physical environment, a 3D position of the second device relative to a 3D model of the physical environment, or any other type of positional data.

The method identifies a content item (e.g., document, 3D model, webpage, communication session instance, shared viewing session instance, etc.) used via the second device. For example, this may involve determining that the second device is currently using a particular content item within a particular application or that the second device is currently displaying a particular content item. In another example, this involves identifying a content item that was most recently used by a particular application or most recently displayed on the second device.

The method provides a view of an extended reality (XR) environment based on the physical environment, where the view comprises a depiction of the second device and an indicator corresponding to the content item, where the indicator is positioned based on the position of the second device. The positioning of the indicator may indicate that the second device is (or was recently) using or displaying the content item. The indicator may have a variety of forms including, but not limited to, being a notification, affordance, link, or the like. An indicator may be overlaid on passthrough video that includes a depiction of the second device. The indicator may be triggered or conditioned based on a context. For example, opening a word processor on the first device may trigger display of indicators of one or more word processing documents that were recently used on the second device. The indicator may only be displayed when the second device is unlocked or when the two devices are accessed by one or more users associated with the same user/group account. Interaction with the indicator may trigger a handoff or “casting” of the content item from the first device to the second device, which may enable the user to continue using the content item on the first device.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B illustrate a physical environment in which electronic devices are used in accordance with some implementations.

FIGS. 2A, 2B, and 2C illustrate display and use of an example indication of a content item in a view of an extended reality environment that is provided based on the physical environment of FIG. 1 in accordance with some implementations.

FIGS. 3A, 3B, 3C, and 3D illustrate display and use of another example indication of a content item in a view of an extended reality environment that is provided based on the physical environment of FIG. 1 in accordance with some implementations.

FIG. 4 illustrates another physical environment in which electronic devices are used in accordance with some implementations.

FIGS. 5A and 5B illustrate display and use of an example indication of a content item in a view of an extended reality environment that is provided based on the physical environment of FIG. 4 in accordance with some implementations.

FIG. 6 is a flowchart illustrating a method for providing an indication of a content item used via another device in accordance with some implementations.

FIG. 7 is a block diagram of an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

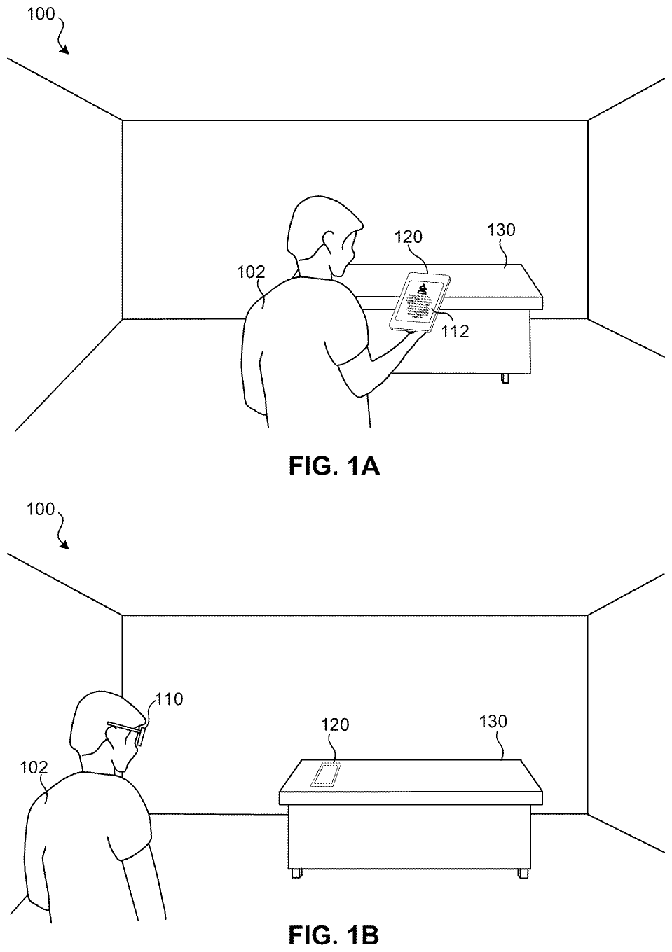

FIGS. 1A and 1B illustrate a physical environment 100 in which exemplary electronic devices 110, 120 are used by a user 102. The physical environment 100 in this example is room that includes a desk 130. In FIG. 1A, the second electronic device 120 is a tablet type device that executes a web browser application to display a content item 112, e.g., a website relating to the U.S. Constitution.

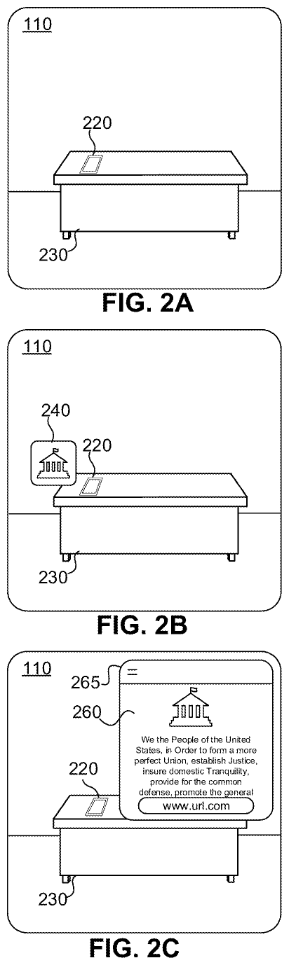

In FIG. 1B, the user 102 currently uses the first electronic device 110 and has set the second electronic device 120 down on the top surface of table 130. The first electronic device 110 provides views of an XR environment that include depictions of the second electronic device 120 as well as indications corresponding to the content item 112 that is/was used by the second electronic device 120. Example views are illustrated in FIGS. 2A-C and 3A-D, as described below.

The first electronic device 110 includes one or more cameras, microphones, depth sensors, or other sensors that can be used to capture information about and evaluate the physical environment 100 and the objects within it, as well as information about the user 102. The information about the physical environment 100 or user 102 may be used to provide visual and audio content or to identify the current location of the physical environment 100 or the location of the user and objects (such as the second electronic device 120) within the physical environment 100. In some implementations, views of an extended reality (XR) environment may be provided. Such an XR environment may include views of a 3D environment that is generated based on camera images or depth camera images of the physical environment 100 as well as a representation of user 102 based on camera images or depth camera images of the user 102. Such an XR environment may include virtual content that is overlain on views of the physical environment 100 or that is positioned at 3D locations relative to a 3D coordinate system associated with the XR environment, which may correspond to a 3D coordinate system of the physical environment 100.

A physical environment refers to a physical world that people can sense or interact with without aid of electronic systems. The physical environment may include physical features such as a physical surface or a physical object. For example, the physical environment corresponds to a physical park that includes physical trees, physical buildings, and physical people. People can directly sense or interact with the physical environment, such as through sight, touch, hearing, taste, and smell. In contrast, an extended reality (XR) environment refers to a wholly or partially simulated environment that people sense or interact with via an electronic device. For example, the XR environment may include augmented reality (AR) content, mixed reality (MR) content, virtual reality (VR) content, or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect rotational head movement and, in response, adjust graphical content and an acoustic field presented to the person in a manner similar to how such views and sounds would change in a physical environment. As another example, the XR system may detect rotational or translational movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), adjustments to characteristic(s) of graphical content in an XR environment may be made in response to representations of physical motions (e.g., vocal commands).

There are many different types of electronic systems that enable a person to sense or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

FIGS. 2A, 2B, and 2C illustrate display and use of an example indication of a content item in a view of an extended reality environment that is provided based on the physical environment 100 of FIGS. 1A-B. FIG. 2A illustrates a view of the XR environment that includes depictions of the physical environment 100, including a depiction 230 of desk 130 and a depiction 220 of device 120. Such a view may be provided by providing pass-through video images from an image capture device to a display device on device 110. Alternatively, such a view may be provided by generating a view using images or sensor data captured in physical environment 100, e.g., images, depth sensor data, etc. In some implementations, a 3D representation of the physical environment 100 is generated and used to provide some or all of the view of the XR environment including depictions of the physical environment 100. In yet other examples, the view of the XR environment may include a view of the physical environment 100 through a transparent or translucent display of device 110.

FIG. 2B illustrates virtual content added into the XR environment to provide an indication that a content item is or was being used on a device depicted in the view. Specifically, indication 240 is displayed to indicate that a content item 112 (FIG. 1A), e.g., a website relating to the U.S. Constitution, is or was being used on the device 120. The indication 240 is provided based on determining the location of the device 120 in the physical environment. The location may be determined in various ways. For example, the location may be determined using sensor data, e.g., via computer vision of live captured image data, radio-based localization (e.g., using ultra-wideband technology), or other sensor data analysis. In another example, the location may be alternatively or additionally determined based on timing electronic communication signals, e.g., time of flight analysis.

In the example of FIG. 2B, the determined location is used to display the indication 240, e.g., by positioning the indication 240 proximate the depiction 220 of the device 120 in the view of the XR environment. The indication 240 may be within a threshold distance of the depiction 220 of the device 120. For example, the indication 240 may be within a fixed number of pixels away from the depiction 220 of the device 120 in a 2D image the forms the view. In another example, the indication 240 may overlap (e.g., at least partially) the depiction 220 of the device 120 in such an image. In another example, the indication 240 may be assigned a 3D position in a 3D coordinate system in which the depiction 220 or corresponding device 120 is positioned and be within a threshold distance in that 3D coordinate system. The indication may be assigned a 3D position that is selected as a closest available position that satisfies certain criteria, e.g., on the closest surface, at a closest position not obscuring other users or other content of predetermined types/characteristics, etc. In some implementations, the 3D position is automatically selected based on user-specified criteria or context information. The indication 240 may be provided at a fixed position or at an anchored position, e.g., so that the indication moves 240 when the depiction 220 or corresponding device 120 moves. In other examples, the indication 240 points to, encircles, or otherwise graphical indicates the relationship to the depiction 220 of the device 120.

The indication 240 may provide an indication of the type of the content item (e.g., webpage, 3D model, word processing document, spreadsheet, etc.), the application used to create and edit the content item (e.g., word processor brand X, etc.), the actual content of the content item, e.g., identifying that the website relates to the U.S. Constitution, or other useful/descriptive information about the content item. In some implementations, an indication is only displayed if one or more criteria are met, e.g., the first device is capable of presenting the content item, the second device is unlocked, the content item is not subject to a handoff restriction, etc.

The indication 240 may be an interactable user interface element. For example, user input (e.g., hand gesture, gaze input, etc.) may be used to select or activate the indication 240 to cause an action or response. For example, as illustrated in FIG. 2C, activation of the indication 240 may be used to trigger a handoff of the content item from device 120 to device 110. This may involve device 120 identifying the content item to device 110, sending a copy of the content item to device 110, sending a link or other source information from which device 110 can access the content item, or otherwise exchanging information between device 110 and device 120 via electrical communications channels or via information that can be detected by device sensors such that the first device 110 is enabled to provide the content item. In this example, the first device 110 launches a web browser application with a user interface 265 that displays webpages within the XR environment that it is providing and displays content item 260, which is another instance of content item 112 (e.g., the website relating to the U.S. Constitution) that was used on the second device 120.

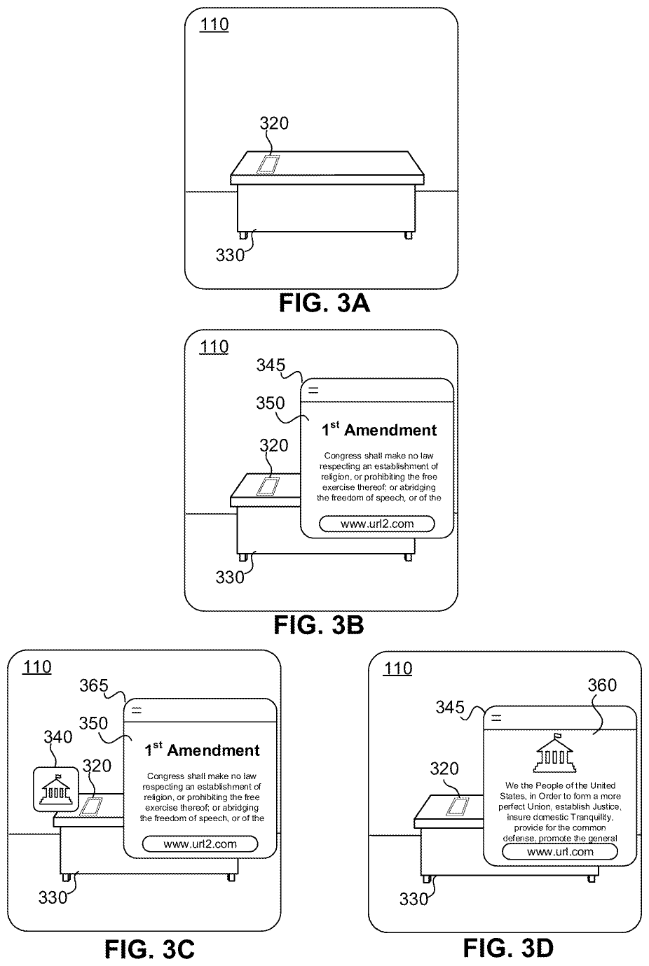

FIGS. 3A, 3B, 3C and 3D illustrate display and use of another example indication of a content item in a view of an XR environment that is provided based on the physical environment of FIG. 1. FIG. 3A illustrates a view of the XR environment that includes depictions of the physical environment 100, including a depiction 330 of desk 130 and a depiction 320 of device 120. Such a view may be provided by providing pass-through video images from an image capture device to a display device on device 110. Alternatively, such a view may be provided by generating a view using images or sensor data captured in physical environment 100, e.g., images, depth sensor data, etc. In some implementations, a 3D representation of the physical environment 100 is generated and used to provide some or all of the view of the XR environment including depictions of the physical environment 100. In yet other examples, the view of the XR environment may include a view of the physical environment 100 through a transparent or translucent display of device 110.

FIG. 3B illustrates a user interface 345 provided in the XR environment by a web browser application executing on electronic device 110. The user interface 345 displays a content item 350, which in this example is from a 1^{st} Amendment website.

In FIG. 3C, based on the context of the web browser application executing and being in current use in the XR environment, the electronic device 110 determines to provide a graphical indicator 340. The graphical indicator 340 provides an indication that a content item is or was being used on a device depicted in the view. Specifically, indication 340 is displayed to indicate that a content item 112 (FIG. 1A), e.g., a website relating to the U.S. Constitution, is or was being used on the device 120. The indication 340 is provided based on determining the location of the device 120 in the physical environment. In this example, that location is used to display the indication 340, e.g., by positioning the indication 340 proximate the depiction 320 of the device 120 in the view of the XR environment. In this example, the indication 340 is only displayed if one or more context criteria are met, e.g., an application capable of presenting content item 112 is in current use in the XR environment.

The indication 340 may be an interactable user interface element. For example, user input (e.g., hand gesture, gaze input, etc.) may be used to select or activate the indication 340 to cause an action. For example, as illustrated in FIG. 3D, activation of the indication 340 may be used to trigger a handoff of the content item from device 120 to device 110. In this example, the first device 110 automatically navigates to display content item 360, which is another instance of content item 112 (e.g., the website relating to the U.S. Constitution), and thus navigates away from content item 350 (e.g., the website relating to the 1^{st} Amendment) that was previously displayed.

In the examples of FIGS. 2A-C and 3A-D, indicators are used to identify currently or recently used content item from the second device 120. In some implementations, criteria are used to select one or more content items that were previously used on the second device for which indications are provided. For example, a content item may be selected that is not the most recently used content item on the second device 120 based on certain criteria. For example, such a content item may be more relevant to the user's current circumstances and thus prioritized over more recently used content items. Focus states or other use states may be used to identify particular contexts in which the devices 110, 120 are used, e.g., personal, school, work, sleep, mediation, exercise/activity, etc. While in a work state, the first device 110 may only display indicators to content items used on the second device 120 that are also associated with the work state and thus exclude indications corresponding to more recently used content items associated with the personal state.

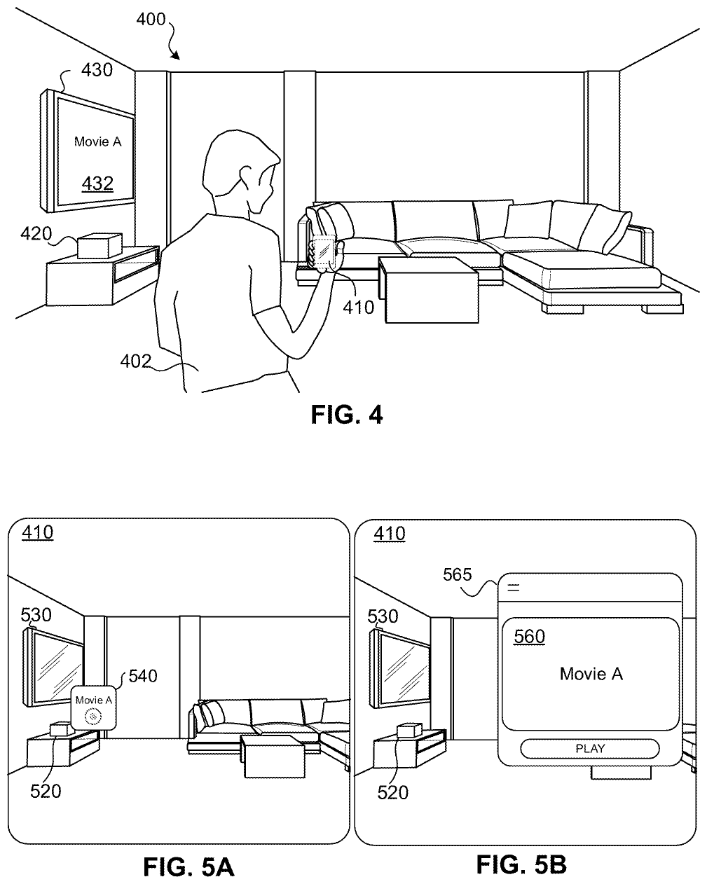

FIG. 4 illustrates another physical environment 400 in which electronic devices 410, 420, 430 are used by a user 402. The physical environment 400 in this example is room that includes furniture, a television content device 420, and television 430. The television content device 420 provides a content item 432 that is displayed on the television 430, e.g., Movie A. The user 402 is holding the first electronic device 410, which provides views of an XR environment that includes depictions of the television content device 420 and television 430 as well as indications corresponding to the content item 432 that is/was used by these devices. Example views are illustrated in FIGS. 5A-5B, as described below.

The first electronic device 410 includes one or more cameras, microphones, depth sensors, or other sensors that can be used to capture information about and evaluate the physical environment 400 and the objects within it, as well as information about the user 402. The information about the physical environment 400 or user 402 may be used to provide visual and audio content or to identify the current location of the physical environment 400 or the location of the user and objects (such as the television content device 420 and television 430) within the physical environment 400. In some implementations, views of an extended reality (XR) environment may be provided. Such an XR environment may include views of a 3D environment that is generated based on camera images or depth camera images of the physical environment 400 as well as a representation of user 402 based on camera images or depth camera images of the user 402. Such an XR environment may include virtual content that is overlain on views of the physical environment 400 or that is positioned at 3D locations relative to a 3D coordinate system associated with the XR environment, which may correspond to a 3D coordinate system of the physical environment 400.

FIGS. 5A and 5B illustrate display and use of an example indication of a content item in a view of an XR environment that is provided based on the physical environment 400 of FIG. 4. FIG. 5A illustrates a view of the XR environment that includes depictions of the physical environment 400, including a depiction 520 of the television content device 420 and a depiction 530 of the television 430. Such a view may be provided by providing pass-through video images from an image capture device to a display device on device 410. Alternatively, such a view may be provided by generating a view using images or sensor data captured in physical environment 400, e.g., images, depth sensor data, etc. In some implementations, a 3D representation of the physical environment 400 is generated and used to provide some or all of the view of the XR environment including depictions of the physical environment 400. In yet other examples, the view of the XR environment may include a view of the physical environment 400 through a transparent or translucent display of device 410.

FIG. 5A illustrates virtual content added into the XR environment to provide an indication that a content item is or was being used on a device depicted in the view. Specifically, indication 540 is displayed to indicate that a content item 432 (FIG. 4), e.g., a Movie A, is or was being used by the television content device 420 and television 430. The indication 540 is provided based on determining the locations of the television content device 420 and television 430 in the physical environment 400 or their corresponding depictions 520, 530 in the view. In this example, one or both of those locations is used to display the indication 540, e.g., by positioning the indication 540 proximate both depictions 520, 530 in the view.

The indication 540 may be an interactable user interface element. For example, user input (e.g., touch input, mouse input, gaze input, etc.) may be used to select or activate the indication 540 to cause an action. For example, as illustrated in FIG. 5B, activation of the indication 540 may be used to trigger a handoff of the content item from device 420 to device 410. This may involve device 420 identifying the content item to device 410, sending a copy of the content item to device 410, sending a link or other source information from which device 410 can access the content item, or otherwise exchanging information between device 410 and device 420 via electrical communications channels or via information that can be detected by device sensors such that the first device 410 is enabled to provide the content item. In this example, the first device 410 launches a movie player application with a user interface 565 that displays movies on a virtual movie screen within the XR environment that it is providing and displays content item 560, which is another instance of content item 532 (e.g., Movie A).

In some implementations, a content item is cast from one device to another. For example, device 420 may execute a player application with casting capabilities and provide the casted content to the device 410, which presents the content within a casting user interface.

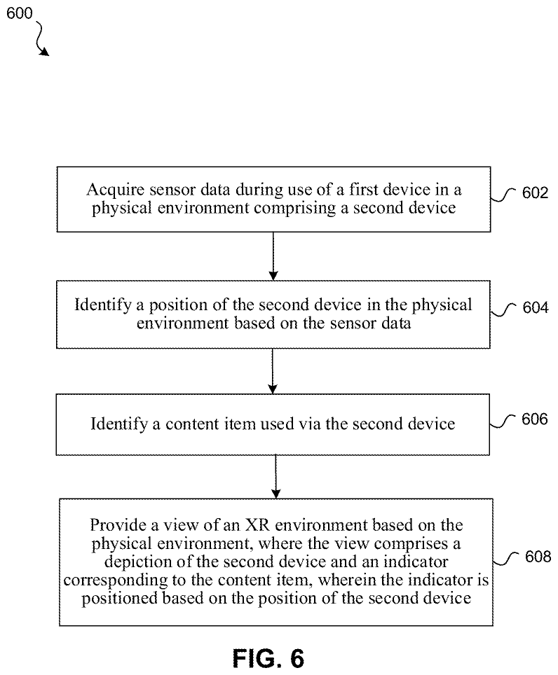

FIG. 6 is a flowchart illustrating a method 600 for providing an indication of a content item used via another device. In some implementations, a device such as electronic device 110 or device 410 performs method 600. In some implementations, method 600 is performed on a mobile device, desktop, laptop, HMD, or server device. The method 600 is performed by processing logic, including hardware, firmware, software, or a combination thereof. In some implementations, the method 600 is performed on a processor executing code stored in a non-transitory computer-readable medium (e.g., a memory).

At block 602, the method 600 acquires sensor data during use of the first device in a physical environment comprising a second device. For example, the sensor data may include RGB, lidar-based depth, densified depth, audio, etc.

At block 604, the method 600 identifies a position of the second device in the physical environment based on the sensor data. As examples, this may involve identifying an x, y, z position in a world coordinate system, a relative position to the first device, etc.

At block 606, the method 600 identifies a content item (e.g., document, 3D model, webpage, communication session, shared content viewing session, etc.) used via the second device.

At block 608, the method 600 provides a view of an extended reality (XR) environment based on the physical environment, where the view comprises a depiction of the second device and an indicator corresponding to the content item, where the indicator is positioned based on the position of the second device. The positioning of the indicator may indicate that the second device is the source of the content item. The indicator may be a notification, affordance, link, etc. The indicator may be triggered/conditioned based on context, e.g., opening a word processor on the first device may trigger display of indicators of word processing docs recently used on the second device. The indicator may only be displayed when the second device is unlocked, the devices are associated with the same account, etc. Interaction with the indicator may trigger a handoff or “casting” of content from the first device to the second device, which may be configured avoid the second device having the separately login to a network source to access the content item.

The method 600 may determine to provide an indicator of content items used on the second device based on determining the content item is currently in use or was the most recently access content item on the second device. The method may determine to provide the indicator based on determining that the second device is currently unlocked or has been locked for less than a threshold amount of time. The method 600 may determine to provide the indicator based on determining that the first device and the second device are currently accessed using a same user account. The method 600 may determine to provide the indicator based on user input accessing, on the first device, an application corresponding to a type of the content item.

The method 600 may receive input corresponding to the indicator and, based on the input corresponding to the indicator, initiate a handoff of the content item from the second device to the first device. The method 600 may receive input corresponding to the indicator and, based on the input corresponding to the indicator, initiate a casting of the content item from the second device to the first device.

In some implementations, the first device accesses the first content item from a content source using login credentials and casts the content item to the second device without the second device using the login credentials to access the content item from the content source.

In some implementations, the method 600 may receive input corresponding to the indicator and, based on the input corresponding to the indicator: obtain a representation of the content item from the second device; and display the content item based on the representation of the content item.

In some implementations, the method 600 may involve a representation of the content item that comprises: the content item; a link to the content item; or a visual representation of the content item.

In some implementations, in the method 600, the representation of the content item comprises the visual representation of the content item, the visual representation of the content item generated by the second device by accessing the content item from a content source using login credentials and the visual representation of the content item is received from the second device without the first device using the login credentials to access the content item from the content source.

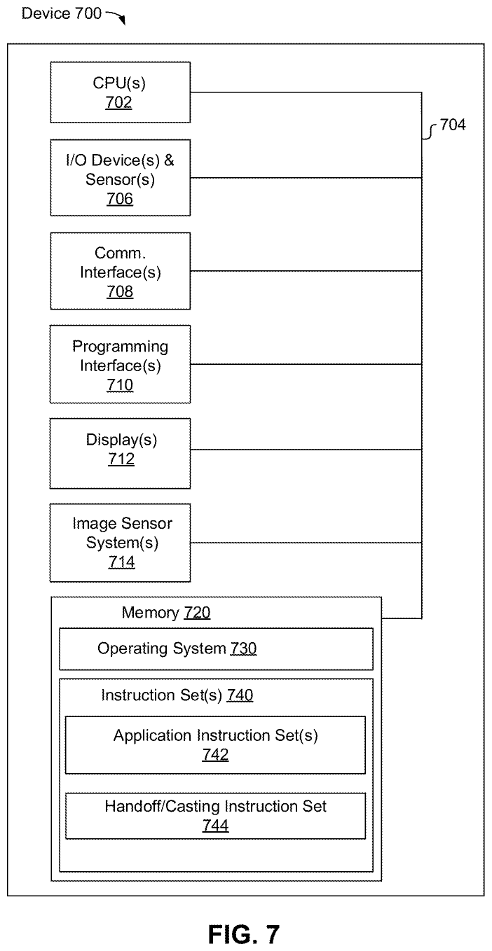

FIG. 7 is a block diagram of electronic device 700. Device 700 illustrates an exemplary device configuration for electronic device 110 or electronic device 410. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, or the like type interface), one or more programming (e.g., I/O) interfaces 710, one or more output device(s) 712, one or more interior or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), or the like.

In some implementations, the one or more output device(s) 712 include one or more displays configured to present a view of a 3D environment to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), or the like display types. In some implementations, the one or more displays correspond to diffractive, reflective, polarized, holographic, etc. waveguide displays. In one example, the device 700 includes a single display. In another example, the device 700 includes a display for each eye of the user.

In some implementations, the one or more output device(s) 712 include one or more audio producing devices. In some implementations, the one or more output device(s) 712 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1512 may additionally or alternatively be configured to generate haptics.

In some implementations, the one or more image sensor systems 714 are configured to obtain image data that corresponds to at least a portion of a physical environment. For example, the one or more image sensor systems 714 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 comprises a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 include application instruction set(s) 742 configured to, upon execution, anchor or provide user interfaces of one or more content applications within an XR environment as described herein. The instruction set(s) 740 further include a handoff/casting instruction set 1544 configured to, upon execution, provide indications of content items used by other device or facilitate handoff/casting of content items between devices as described herein. The instruction set(s) 740 may be embodied as a single software executable or multiple software executables.

Although the instruction set(s) 740 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information or physiological data will comply with well-established privacy policies or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a first device having a processor:
acquiring sensor data during use of the first device in a physical environment comprising a second device;
identifying a position of the second device in the physical environment based on the sensor data;
identifying a content item used via the second device; and
providing a view of an extended reality (XR) environment based on the physical environment, wherein the view comprises a depiction of the second device and an indicator corresponding to the content item, wherein the indicator is positioned based on the position of the second device.

2. The method of claim 1, wherein the indicator is positioned at a location defined relative to the position of the second device.

3. The method of claim 1, wherein the indicator is positioned within a predetermined distance to the depiction of the second device.

4. The method of claim 1, wherein the indicator is overlaid on passthrough video of the physical environment.

5. The method of claim 1 further comprising determining to provide the indicator based on determining the content item is currently in use on the second device.

6. The method of claim 1 further comprising determining to provide the indicator based on determining that the second device is currently unlocked or has been locked for less than a threshold amount of time.

7. The method of claim 1 further comprising determining to provide the indicator based on determining that the first device and the second device are currently accessed using a same user account.

8. The method of claim 1 further comprising determining to provide the indicator based on user input accessing, on the first device, an application corresponding to a type of the content item.

9. The method of claim 1 further comprising:
receiving input corresponding to the indicator; and
based on the input corresponding to the indicator:
obtaining a representation of the content item from the second device; and
displaying the content item based on the representation of the content item.

10. The method of claim 9, wherein the representation of the content item comprises:
the content item;
a link to the content item; or
a visual representation of the content item.

11. The method of claim 10, wherein:
the representation of the content item comprises the visual representation of the content item;
the visual representation of the content item generated by the second device by accessing the content item from a content source using login credentials; and
the visual representation of the content item is received from the second device without the first device using the login credentials to access the content item from the content source.

12. The method of claim 1, wherein the content item comprises a document, 3D model, webpage, communication session instance, or shared viewing experience session.

13. The method of claim 1, wherein the indicator comprises a notification, affordance, or link.

14. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
acquiring sensor data during use of the first device in a physical environment comprising a second device;
identifying a position of the second device in the physical environment based on the sensor data;
identifying a content item used via the second device; and
providing a view of an extended reality (XR) environment based on the physical environment, wherein the view comprises a depiction of the second device and an indicator corresponding to the content item, wherein the indicator is positioned based on the position of the second device.

15. The system of claim 14, wherein the indicator is positioned at a location defined relative to the position of the second device.

16. The system of claim 14, wherein the indicator is positioned within a predetermined distance to the depiction of the second device.

17. The system of claim 14, wherein the indicator is overlaid on passthrough video of the physical environment.

18. The system of claim 14, wherein the operations further comprise determining to provide the indicator based on determining the content item is currently in use on the second device.

19. The system of claim 14, wherein the operations further comprise determining to provide the indicator based on determining that the second device is currently unlocked or has been locked for less than a threshold amount of time.

20. A non-transitory computer-readable storage medium storing program instructions executable via one or more processors to perform operations comprising:
acquiring sensor data during use of the first device in a physical environment comprising a second device;
identifying a position of the second device in the physical environment based on the sensor data;
identifying a content item used via the second device; and
providing a view of an extended reality (XR) environment based on the physical environment, wherein the view comprises a depiction of the second device and an indicator corresponding to the content item, wherein the indicator is positioned based on the position of the second device.
